(19) United States
(12) Patent Application Publication
(10) Pub. No.: US 2022/0182096 A1
(43) Pub. Date: Jun. 9, 2022

(54) A CASE FOR MOBILE DEVICE WITH A SCREEN

(71) Applicant: TECH 21 LICENSING LIMITED, Middlesex (GB)

(72) Inventors: Haim GEVA, Middlesex (GB); Amirah HAKIMAH BINTI ABD AZIZ AL RAHMAN, Middlesex (GB)

(21) Appl. No.: 17/601,291

(22) PCT Filed: Apr. 2, 2020
(86) PCT No.: PCT/GB2020/050880

§ 371 Date: Oct. 4, 2021

(30) Foreign Application Priority Data
Apr. 4, 2019 (GB) 1904770.3

(51) Int. Cl. H04B 1/3888; H04M 1/02

(52) U.S. Cl. CPC H04B 1/3888; H04M 1/0202

(57) ABSTRACT

A case (1) for a mobile device with a screen. The case comprises a body forming a cavity to receive the device, at least part of the body being formed of a polymer (9), a pair of electrically conductive tracks (6, 7, 8) for an electrical circuit. The case (1) is provided with a means (12) for connecting to the mobile device such that a measurable current is communicated to the mobile device. The tracks are integrally formed within the body and are formed of a polymer impregnated with electrically conductive elements. The terminal ends (6) of the tracks are exposed at an outer surface of the case in close proximity to one another to form a switch (5), such that, in use, a finger pressed onto the case between the terminal ends closes the switch to complete the electrical circuit causing the measurable current to flow.

The present invention relates to a case for a mobile device with a screen.

The invention has been particularly designed for touch screen mobile devices which are often used for gaming, such as smartphones and tablets. However, it could also be used for other types of devices such as E-readers.

Games on touch screen devices are generally controlled via the touch screen interface. This can have the effect of interfering with visual aspects of the game as the user is required to cover at least a portion of the screen with their hands in order to interface with the game.

A number of add-on devices have been proposed to provide gaming interfaces for smartphones. These are generally relatively large devices which are designed to provide an enhanced grip and have a mechanical interface which engages with the touch screen. These are therefore large cumbersome devices which are not widely used and the mechanical interfaces tend to interfere with the touch screen.

There are a number of prior art documents, such as US2015/180527, U.S. Pat. No. 9,807,483, US2013/184077, US2013/341214, US2010/081505, US2011/188222, U.S. Pat. No. 8,825,123 and WO 2017/144921 which disclose cases with buttons which interface with the device.

The present invention aims to provide a case which is capable of providing an interface with the mobile device which can be used, for example, in gaming which is more compact and which does not interfere with the screen or the device.

According to the present invention there is provided a case according to claim 1.

The present invention is therefore able to provide at least one switch using conductive particles impregnated into the polymer such that it is fully integrated into the material of the case itself and which is operated by the user simply by finger contact on the outer surface of the case. This causes a current to flow which is then communicated to the mobile device so as to provide an interface with the device which is useful particularly in gaming applications, but can be used as a user interface with any aspect of the device.

While similar devices do generally have a number buttons around their sides, these are not generally used as a gaming interface, not least because the position of the buttons is not optimised for gaming. The present invention therefore provides a case which provides an enhanced interface for a mobile device which can be optimised for certain conditions such as the gaming to provide functionality not available from the device itself.

The means for connecting to the mobile device may be a physical connection which plugs into a port in the mobile device. However, preferably, the means for connecting to the mobile device is an oneness connection, may, for example, be Bluetooth or RF ID, but is preferably a near-field communication (NFC) device. Power for the circuit may be provided on the case itself in the form of a battery or drawn from the battery of the phone via a cable connector. However, preferably, if the means for connecting to the mobile device is an NFC device, power may be drawn from the mobile device via the NFC device. In this case, the case may be provided with a power storage means such as a rechargeable battery or capacitor

The present invention requires that at least part of the body is formed of a polymer. In practice, the case may simply be a band which surrounds four sides of the case. However, preferably, the case is also provided with a back. In addition to the part formed in the polymer, other materials may be used, for example to provide a softer internal cushioning part, or a harder outer shell.

Preferably the polymer which is used to provide the conductive tracks is the same polymer used for the surrounding part of the case in order to avoid any material incompatibilities.

Suitable polymers for this purpose include a thermoelastic polymer such as TPU, TPV or TPE, or plasticised or unplasticised engineering polymer such as polycarbonate, PET, Nylon or PLA

The conductive elements may be any suitably conductive material which can be impregnated into the polymer, but are preferably carbon black particles, or more preferably carbon nanotubes.

There may be only a single pair of electrically conductive tracks to form a single switch on the case. However, preferably, there are pluralities of pairs of electrically conductive tracks in order to form a plurality of switches around the case. Most preferably, there are two pairs of tracks to provide a pair of switches towards opposite ends of a long side of the mobile device. When the device is held in landscape mode, these switches are conveniently positioned to be operated by the index fingers of a user.

The insulation between the terminal ends of the tracks may be provided via an air gap or by a separate material. However, preferably, the gap between the terminal ends of the tracks is filled with the polymer of the body. This provides a simple instruction which can readily be integrated into the surrounding case.

The tracks may be formed separately and assembled into the case. However, preferably, at least the part of the case with the conductive tracks is formed by 3D printing. All of the case may be 3D printed. Alternatively, part of the case (e.g. the base and/or sidewalls which do not have the tracks) may be injection moulded and the part with the tracks is 3D printed.

An example of a case in accordance with the present invention will now be described with reference to accompanying drawings in which:

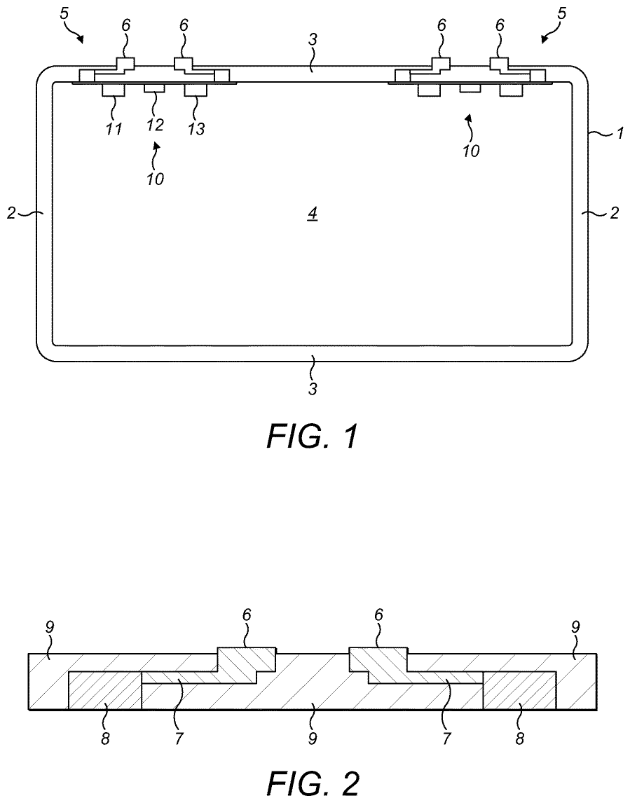

FIG. 1 is a schematic plan view of the case;

FIG. 2 is a cross-section through part of the wall of the case containing a switch;

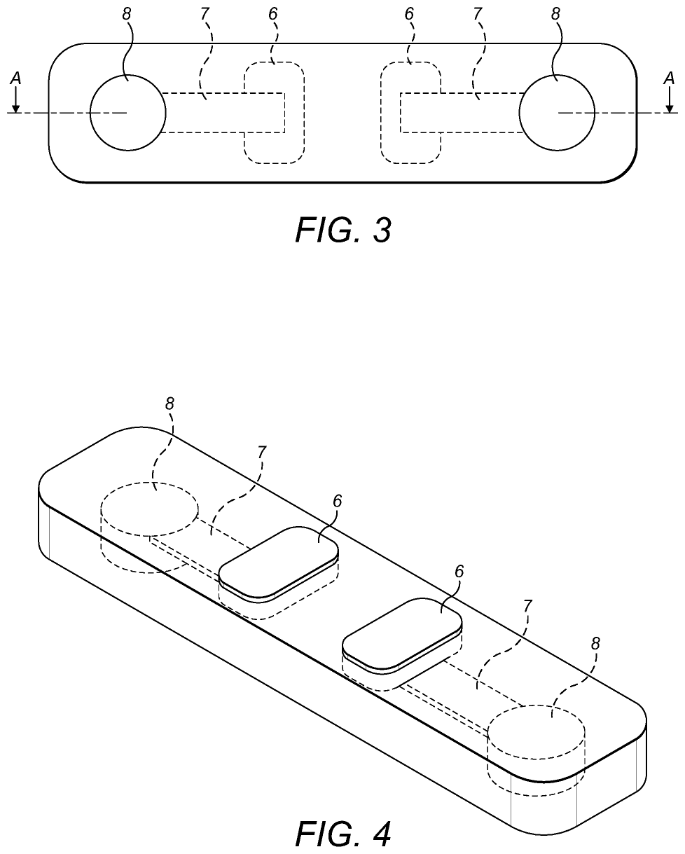

FIG. 3 is a plan view of FIG. 2; and

FIG. 4 is a schematic perspective view corresponding to FIGS. 2 and 3.

The case 1 as shown in FIG. 1 is based on a conventional case for a mobile device such as a smartphone, tablet or the like. It has two short sidewalls 2 and two long sidewalls 3 forming a generally rectangular cavity which is optionally closed by a back wall 4.

The present invention relates to the switch 5 which is built into one of the sidewalls. As shown in FIG. 1, there are two switches 5 at either end of one of the long sidewalls 3. However, the switches can be anywhere around periphery of the case, and even in the back wall 4. The principal behind the switch is the same no matter where it positioned.

This will now be described in greater detail with reference to FIGS. 2 to 4. The switch 5 comprises a pair of contacts 6 which are exposed at the external face of the case. The contacts 6 could equally be flush with the surface of the case. Each contact 6 is an electrical contact with a connector line 7 which leads to an internal contact 8. In an alternative arrangement, the contact 6 and internal contact 8 may be aligned so that they extend directly through the wall of the case without the need for the connector line 7.

The case 1 is formed at least in part by a polymer 9 which forms the bulk of the case and in particular, forms the insulation between the contacts 6 as shown in FIG. 2. Other materials might be used in the case in addition to the polymer 9 provided that the contacts 6 remain accessible.

The contact 6, connector line 7 and internal contacts 8 are preferably formed of the same polymer impregnated with particles of a conductive material such as carbon black or carbon nanotubes.

The internal contacts 8 connect to circuitry 10 mounted into the inner wall 3. This is depicted only schematically in FIG. 1 and does not project in practice from the wall of the case as shown.

The circuitry includes a conductive path between the internal contacts 8 which is connected to a rechargeable battery 11, near field communication (NFC) device 12 and current measuring device 13. The gap between the contacts 6 forms a switch for the circuitry which is closed by a user pressing their finger onto the side of the case so as to bridge the two contacts 6. The causes a current to flow within the circuit. This is detected by the current detector 13 indicating that the user has closed the switch. This information is then transmitted via the NFC device 12 and NFC device on the mobile device such that the closing of the switch can be registered in the software being run on the mobile device.

In place of the NFC chip, there may be a physical connection to one of the ports in the mobile device.

At least the part of the case in the vicinity of the contacts 6 is formed by 3D printing. This may be, for example, just the subassembly shown in FIGS. 2-4 which is then bonded to an injection moulded part forming the bulk of the case. Alternatively the whole case may be 3D printed.

The case lends itself well to 3D printing. As can be seen in FIGS. 2 to 4, the area in the vicinity of the contacts 6 has a simple structure which can easily be 3D printed by a first printer nozzle containing just the polymer and a second printer nozzle containing a polymer (which may be the same as the first polymer) impregnated with particles of a conductive material such as carbon black or carbon nanotubes.

1. A case for a mobile device with a screen, the case comprising a body forming a cavity to receive the device, at least part of the body being formed of a polymer, a pair of electrically conductive tracks for an electrical circuit;
the case further being provided with a means for connecting to the mobile device such that a measurable current is communicated to the mobile device;
characterised in that the tracks are integrally formed within the body and are formed of a polymer impregnated with electrically conductive particles; and
wherein the terminal ends of the tracks are exposed at an outer surface of the case in close proximity to one another to form a switch, such that, in use, a finger pressed onto the case between the terminal ends closes the switch to complete the electrical circuit causing the measurable current to flow.

2. A case according to claim 1, comprising when the means for connecting to the mobile device is an NFC device.

3. The case according to claim 1, further comprising a power storage device.

4. The case according to claim 2, wherein the power storage device is rechargeable via the NFC device.

5. The case according to claim 1, wherein the polymer forming the body is the same as the polymer forming the tracks.

6. The case according to claim 1, wherein the conductive elements are carbon nanotubes.

7. The case according to claim 1, wherein there are a plurality of pairs of electrically conductive tracks in order to form a plurality of switches around the case.

8. The case according to claim 1, wherein the polymer of the body provides the insulation between the terminal ends of the tracks.

9. The method for forming a case according to claim 1 by 3D printing at least the part of the case with the conductive tracks.
